(19) United States
(12) Patent Application Publication
(10) Pub. No.: US 2012/0089919 A1
(43) Pub. Date: Apr. 12, 2012

(54) LEVERAGING SOCIAL NETWORKING FOR COMPUTER HELP

(75) Inventors: Sean Patrick Kennedy, San Diego, CA (US); Fredrik Carpio, Menifee, CA (US); Adrian Crisan, San Diego, CA (US); Rommel Garay, San Marcos, CA (US); Gary Robert Lyons, San Diego, CA (US); Edward Theodore Winter, San Diego, CA (US)

(73) Assignee: SONY CORPORATION

(21) Appl. No.: 12/898,846

(22) Filed: Oct. 6, 2010

(51) Int. Cl. G06F 3/00; G06F 15/16

(52) U.S. Cl. 715/739; 709/206

(57) ABSTRACT

Computer help is provided through a user's social networking sites. For example, a computer help desk can request permission to be added to a user's social networking contacts or can add itself automatically as a contact of the user to provide help information through the social network as an RSS feed.

### I. FIELD OF THE INVENTION

The present application relates generally to leveraging social networking for computer help.

### II. BACKGROUND OF THE INVENTION

“Social media” is term that encompasses an Internet subset: websites that primarily allow users to interact with each other in a variety of ways. Well known social media sites include Facebook®, Twitter®, and MySpace®. Such sites have met with success: more than four in five US online adults now participate in or consume social media at least once a month. Almost one-quarter of U.S. online adults are creators, i.e., people who write blogs, upload original audio or video, or post stories online.

In many social media sites one user may share content with other users, typically by uploading the content to a content storage site and then have friends and family download it manually. As understood herein, this paradigm can be leveraged by facilitating computer help from expert “friends” on a user's social media list of friends.

### SUMMARY OF THE INVENTION

Accordingly, a server includes a processor communicating with the Internet and a computer readable storage medium accessible to the processor and bearing instructions executable by the processor for receiving from a computing device a designation of which social networking contacts of a user of the computing device are to be solicited for technical help. The server receives from the computing device a request for technical help and accesses from the computing device social networking contact addresses according to which contacts of the user were designated by the user and received by the server. A message is then to the social networking contact addresses requesting that friends contact the user of the computing device through a social network.

In some implementations, once the user of the computing device has uploaded designated social networking help friends the user need do nothing more to invoke technical assistance from those friends beyond pressing an “assist” key. The designation of social networking contacts of the user of the computing device can be received by means of a user interface (UI) presented on the computing device. The designation of social networking contacts of the user of the computing device may include all contacts in the user's various social networking address books or only a user-designated subset thereof.

In example embodiments the request for technical help is generated by a user pressing an “assist” key on the computing device once and once only. The server can send the message to social networking contact addresses only responsive to the server not being able to immediately respond to a user technical question input by the user at the computing device and received by the server.

In some embodiments the server can automatically add itself to one or more social network contact lists stored in the computing device without intervention by the user. The server may be established by a friend computer associated with a social contact of the user of the computing device prior to the user of the computing device entering the request for technical help, or by a help desk server affiliated with a manufacturer of the computing device.

In another aspect, a server includes a processor communicating with the Internet and a computer readable storage medium accessible to the processor and bearing instructions executable by the processor for receiving from a computing device a request for assistance. The instructions include sending a signal to the computing device causing the computing device to present a user interface (UI) on a display of the computing device prompting a user to enter a help question regarding the computing device for which the user requires a technical response. A UI is caused to be presented on the display of the computing device requesting that the server be added as a friend to one or more of the user's social networks. Responsive to the user agreeing to add the server as a friend, a help response is returned to the computing device through a social networking server associated with a social network of the user.

In another aspect, a computing device includes a processor accessing instructions on a computer readable storage medium to control a display for presenting user interfaces (UI) thereon. The instructions include presenting on the display a first UI related to the user's technical skills and responsive to user input on the first UI to advertise the user's skills, presenting on the display a second UI prompting the user to enter his or her qualifications and/or skill sets. The instructions further includes sending the qualifications and/or skills sets to social networking friends of the user appearing in one or more address books stored in the computing device.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing interior components of the computer;

FIG. 2 is a screen shot of an example user interface (UI) for allowing a user to designate which social networking friends he would like to call for technical help;

FIG. 3 is a flow chart showing example logic for invoking technical help from social networking friends;

FIG. 4 is a flow chart showing example logic for invoking technical help from a help desk server as a social networking friend;

FIG. 5 is an example UI that can be presented as part of the logic for FIG. 4;

FIG. 6 is a flow chart showing example logic for a help desk server obtaining access to a user's desktop and automatically adding itself as a social networking friend of the user; and

FIGS. 7-10 are example UIs that can be presented to permit an expert social networking friend to upload help instructions to his social networking contacts and to advertise himself as an expert.

### DETAILED DESCRIPTION OF THE PREFERRED EMBODIMENT

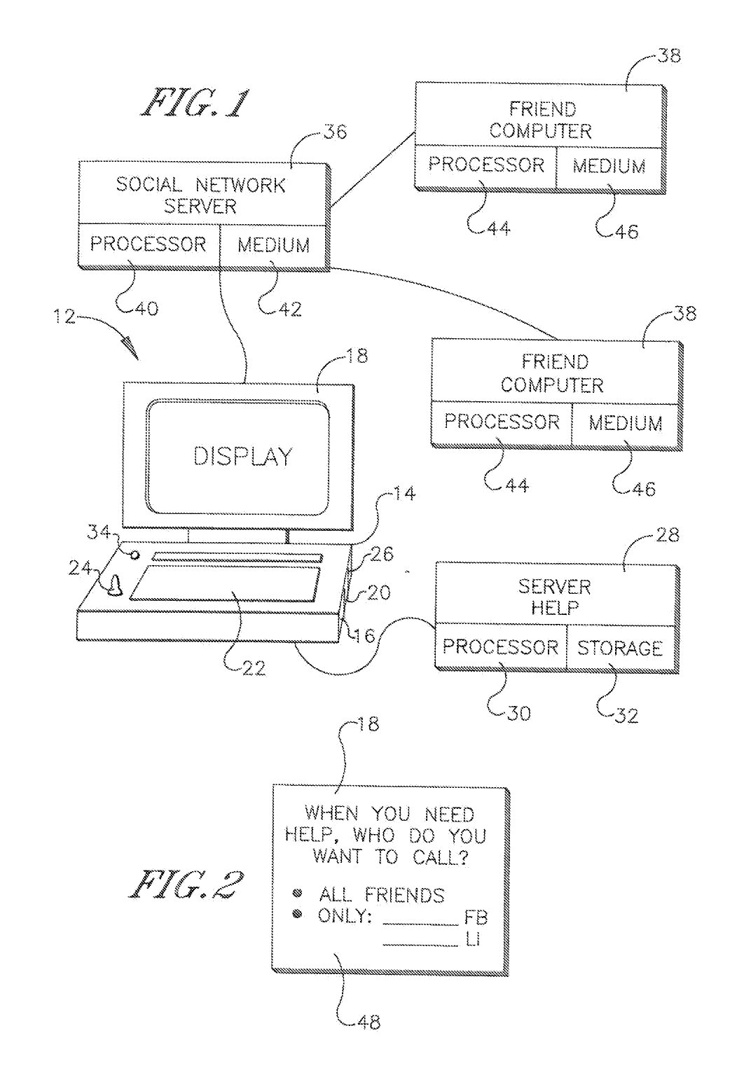

Referring initially to FIG. 1, a computing device 12, also referred to herein as a “user computer”, such as a personal digital assistant, laptop computer, personal computer (PC), etc. includes a housing 14 bearing a digital processor 16. The processor 16 can control a visual display 18 and an audible display such as one or more speakers. The processor 16 may access a media player module such that the device 12 has media decoding capability.

To undertake present principles, the processor 16 may access one or more computer readable storage media 20 such as but not limited to RAM-based storage, a chip implementing dynamic random access memory (DRAM)) or flash memory or disk storage. Software code implementing present logic executable by the device 12 may be stored on one of the memories shown to undertake present principles.

The processor 16 can receive user input signals from various input devices, including a keyboard or keypad 22 (hereinafter “keypad” without loss of generality), a point and click device such as a mouse or joystick 24, etc. A network interface 26 such as a wired or wireless modem or wireless telephony transceiver may also be provided and may communicate with the processor 16 so that information can be exchanged between the computer and one or more help desk servers 28. A help desk server 28 typically includes one or more server processors 30 and one or more server storage devices 32 which may contain executable instructions that can be accessed by the server processors to undertake present logic. In some embodiments the computing device 12 can include a special dedicated “assist” key 34 the purpose of which is explained further below. In other embodiments the assist key function may be provided by other, conventional keys on the keypad 22, e.g., the function may be provided by the “F1” key or by a combination of the simultaneous pressing of multiple predetermined keys.

In addition, the computing device 12 may communicate with one or more social networking servers 36 through which a user can communicate with one or more social networking “friend” computers 38. Likewise, the help desk server 28 may communicate with the social networking servers. The above communication is via a wired and/or wireless wide area network, typically the Internet. Each social networking server 36 typically includes one or more server processors 40 and one or more server storage devices 42 which may contain executable instructions that can be accessed by the server processors to undertake present logic. Also, each friend computer 38 typically includes one or more processors 44 accessing one or more computer readable storage media 46.

Now referring to FIG. 2, a UI 48 is shown that may be presented on the display 18 of the computing device 12 responsive to signals received from the help desk server 28. As shown, the example UI 48 permits a user to enter which of the user's social networking friends are to be contacted in accordance with logic below when the user desires technical help. In example implementations the user can select to have “all friends” contacted, in which case all friends in the user's address book for all the user's social networking accounts are contacted, or a subset of friends, by friend name and/or, as shown, by social networking account. Thus, for example, the user may designate only friends on social network “FB” to be contacted for help but not friends on social network “LI”.

FIG. 3 shows example logic that can be used in conjunction with the UI 48 shown in FIG. 2. Commencing at block 49, a server such as the help desk server 28, which may be affiliated with a manufacturer of the computing device 12, receives from the computing device 12 a designation of which friends in the user's various computer social networks are to be solicited for technical help. The designation can be received by means of the UI 48 shown in FIG. 2 and can include all of the contacts in the user's various social networking address books as described above, of a user-designated subset thereof.

Proceeding to block 50, request for technical help or assistance is received by the server. In some embodiments the request is generated by a user pressing the special “assist” key 34 once and once only. The server then accesses, at block 52, the social networking contact addresses according to which “help” friends were designated by the user and received at block 49. In some embodiments the logic of block 52 may be performed only if the help desk server 28 cannot immediately respond to a user technical question input by the user at the computing device 12 and received by the server 28 when the user presses the “assist” key 34 at block 50.

Proceeding to block 54, the server sends a message to the addresses of the user-designated “help” friends requesting that any friends with particular technical expertise, referred to herein as “mavens”, contact the user through the social network with which the particular friend communicates with the user of the device 12. Thus, once the user of the device 12 has uploaded the designated social networking help friends the user need do nothing more to invoke technical assistance from those friends beyond pressing the “assist” key. The friends, by means of their respective friend computers 38 in FIG. 1, then can provide technical help to the user through the appropriate social networking server 36 as, e.g., real simple syndication (RSS) feeds.

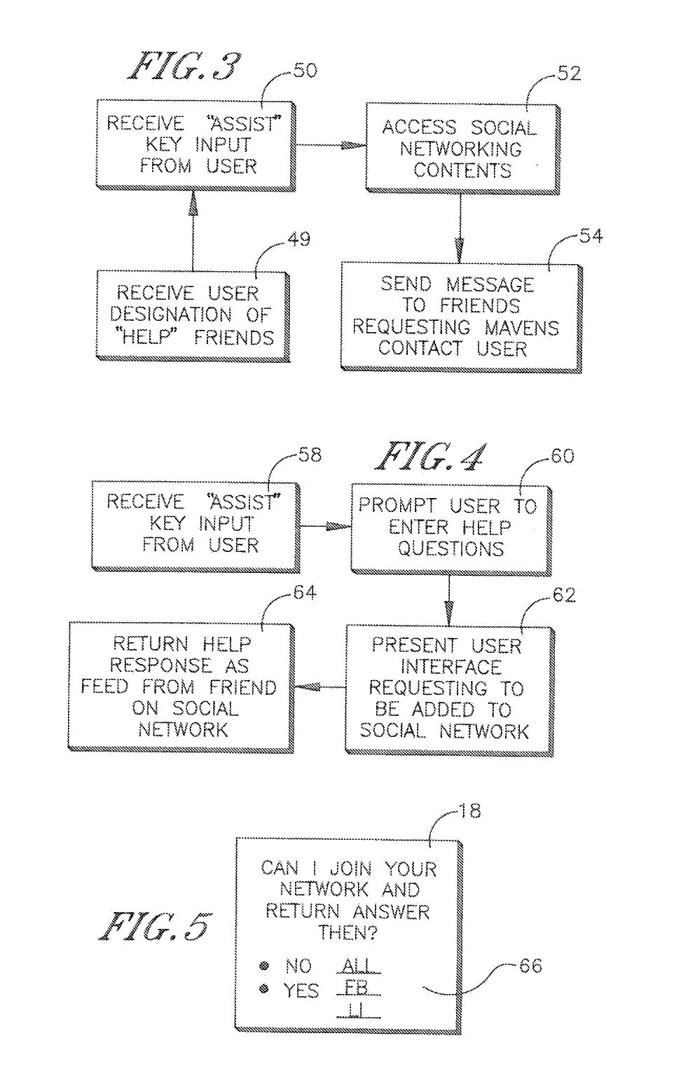

FIG. 4 is a flow chart of alternate logic that may be employed by the help desk server 28. Commencing at block 58 a request for assistance is received from the device 12. The request may be generated by the user pressing the “assist key” 34. Moving to block 60, the server sends a signal to the device 12 causing the device 12 to present a UI prompting the user to enter a help question, i.e., a question regarding the computing device 12 for which the user requires a technical response.

From block 60 the logic moves to block 62 to cause a UI to be presented on the display 18 of the device 12 requesting that the help desk server be added as a friend to one or more of the user's social networks. An example of such a UI is discussed below in reference to FIG. 5. Assuming the user has responded favorably, at block 64 the server 28 returns a help response to the computing device 12 through the social networking service, i.e., through the social networking server 36 associated with the user's social network.

As shown in FIG. 5, a UI 66 may be presented on the display 18 of the computing device 12 responsive to the logic at block 62 of FIG. 4. The UI 66 may request addition of the help desk server 28 to the user's social networking contact list(s) and the user may respond “no” or “yes”. In some implementations, if the user responds “yes” the user may be given the option of selecting to add the server 28 to all of the user's social networking address books/services or to a user-designated subset thereof, e.g., only to social networking service “FB” and to no others.

FIG. 6 shows yet further logic that may be executed by the help desk server 28. Commencing at block 68, a request for assistance is received from the device 12. The request may be generated by the user pressing the “assist key” 34. Moving to block 70 the server 28 sends a request to the computing device 12 to access the desktop of the computing device 12 for the purpose of taking control of the computing device 12 by issuing instructions to the processor 16. If access is not granted at decision diamond 72 the logic ends at state 74, but if access is granted to the desktop of the device 12 the logic flows to block 76 to conduct the user, by means of UIs presented on the display 18, through a predetermined “help” tutorial.

As envisioned by the logic of FIG. 6, the server 28 also automatically adds itself at block 78 to the user's social networking address books as a “friend”, with user name, e.g., of “help desk”. Proceeding to block, for future help requests from the computing device 12, the server 28 responds through one of the social networking servers 36 as a friend of the user using a social networking feed. It is to be understood that the logic of FIG. 6 may also be executed by a friend computer 38, e.g., by the computer of a friend of the user who is a “maven”. In this way, instead of remote help from a friend requiring that a friend initiate a connection, the connection be accepted by the computing device 12, and then the friend accepting the connection to their system 38, a one click action by the user of the computing device 12 requiring help at decision diamond 72 is all that is required. In other words, when the logic is executed by a friend computer 38 a maven friend can set an option that he wants to help the user of the device 12 and the user need only indicate “accept”. The maven can then see everything on the device 12 system without any other interaction necessary.

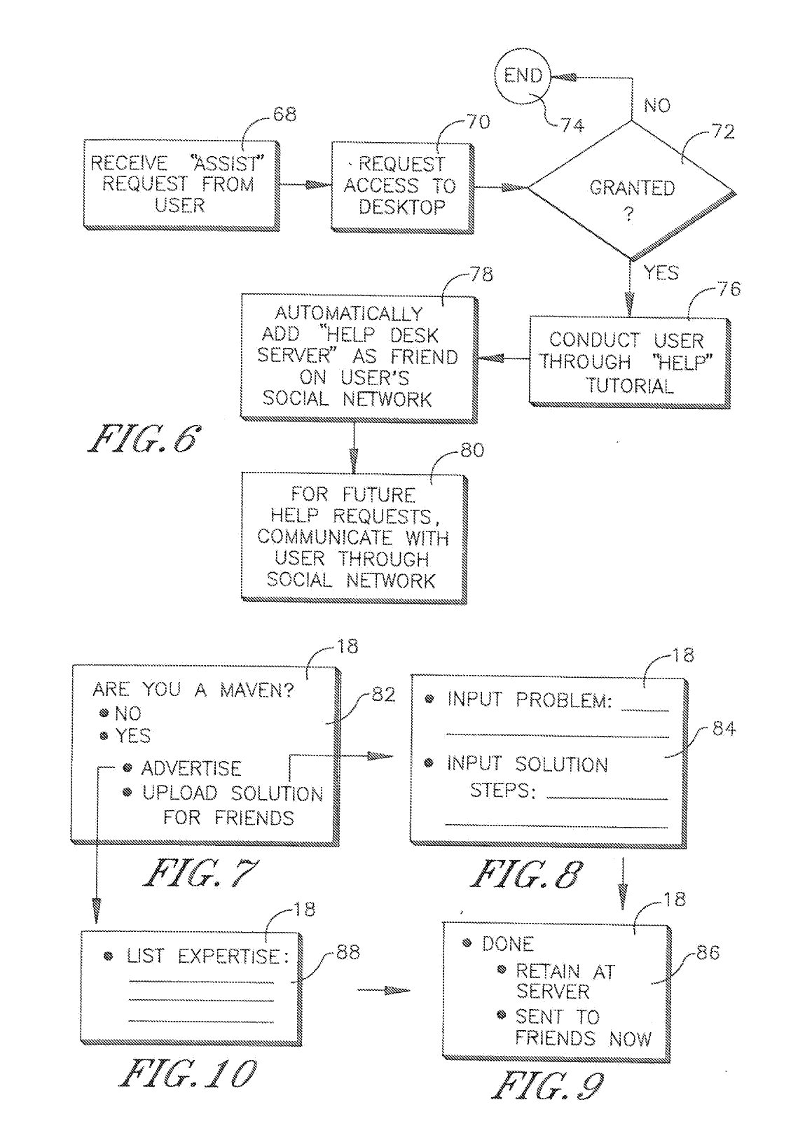

In addition to the above, present principles understand that a user of the computing device 12 may himself be a “maven” that is highly technical and consequently does not require help desk support, but rather can resolve issues and develop a troubleshooting procedure that the user's less technical friends may need in the future. Accordingly, a UI 82 may be presented as shown in FIG. 7 asking whether the user is technically skilled (“maven”). The user can respond “no” but can also respond “yes”, in which case, in the example shown, the user may select to upload a troubleshooting solution the user may have developed and/or to advertise his skills.

FIG. 8 shows a UI 84 that can be presented on the display 18 responsive to the user indicating he is a maven with a troubleshooting solution to upload. As shown, the UI 84 may provide fields for the user to input a problem description and step by step instructions for resolving the problem, which may be embodied as a flash file. Then, a UI 86 (FIG. 9) may be presented allowing the maven user to indicate he is done and to either store the solution at the server 28 (or 36) and/or automatically send the solution to all the friends in the user's social networking address book(s) via the appropriate social networks. Friend computers 38 of the user of the computing device 12 can thus receive the solution without requesting it or even knowing about the potential problem.

Recall that the UI 82 in FIG. 7 may in some embodiments permit a maven user to advertise his skills to friends in the user's social network. Responsive to selection of “advertise” the UI 88 shown in FIG. 10 may be presented on the display 18, prompting the maven user to enter his qualifications and/or skill sets. For example, a user may designate herself as a “technical” source for her friends, and can designate that she has expertise in certain areas. This allows her friends to know what her skills are and what she can help with. When the user enters the qualifications and then selects “return”, for instance, the qualifications of the user are sent via her social networking services to the friends in her various social networking friends list.

While the particular LEVERAGING SOCIAL NETWORKING FOR COMPUTER HELP is herein shown and described in detail, it is to be understood that the subject matter which is encompassed by the present invention is limited only by the claims.

What is claimed is:

1. Server comprising:
processor communicating with the Internet;
computer readable storage medium accessible to the processor and bearing instructions executable by the processor for:
receiving from a computing device a designation of which social networking contacts of a user of the computing device are to be solicited for technical help;
receiving from the computing device a request for technical help;
accessing from the computing device social networking contact addresses according to which contacts of the user were designated by the user and received by the server;
sending a message to the social networking contact addresses requesting that friends contact the user of the computing device through a social network.

2. The server of claim 1, wherein once the user of the computing device has uploaded designated social networking help friends the user need do nothing more to invoke technical assistance from those friends beyond pressing an “assist” key.

3. The server of claim 1, wherein the designation of social networking contacts of the user of the computing device is received by means of a user interface (UI) presented on the computing device.

4. The server claim 3, wherein the designation of social networking contacts of the user of the computing device includes all contacts in the user's various social networking address books.

5. The server claim 3, wherein the designation of social networking contacts of the user of the computing device includes a user-designated subset of contacts in the user's various social networking address books.

6. The server of claim 1, wherein the request for technical help is generated by a user pressing an “assist” key on the computing device once and once only.

7. The server of claim 1, wherein the server sends the message to social networking contact addresses only responsive to the server not being able to immediately respond to a user technical question input by the user at the computing device and received by the server.

8. The server of claim 1, wherein the server automatically adds itself to one or more social network contact lists stored in the computing device without intervention by the user.

9. The server of claim 1, wherein the server is established by a friend computer associated with a social contact of the user of the computing device prior to the user of the computing device entering the request for technical help.

10. The server of claim 1, wherein the server is established by a help desk server affiliated with a manufacturer of the computing device.

11. Server comprising:
processor communicating with the Internet;
computer readable storage medium accessible to the processor and bearing instructions executable by the processor for:
receiving from a computing device a request for assistance;
sending a signal to the computing device causing the computing device to present a user interface (UI) on a display of the computing device prompting a user to enter a help question regarding the computing device for which the user requires a technical response;
causing a UI to be presented on the display of the computing device requesting that the server be added as a friend to one or more of the user's social networks;
responsive to the user agreeing to add the server as a friend returning a help response to the computing device through a social networking-server associated with a social network of the user.

12. The server of claim 11, wherein the request for assistance is generated by the user pressing an “assist key” on the computing device.

13. The server of claim 11, wherein the UI presented on the display of the computing device requesting that the server be added as a friend to one or more of the user's social networks includes an option of adding the server to all of the user's social networking address books/services.

14. The server of claim 11, wherein the UI presented on the display of the computing device requesting that the server be added as a friend to one or more of the user's social networks includes an option of adding the server to a user-designated subset of the user's social networking address books/services.

15. Computing device comprising:
processor accessing instructions on a computer readable storage medium to control a display for presenting user interfaces (UI) thereon, the instructions comprising:
presenting on the display a first UI related to the user's technical skills;
responsive to user input on the first UI to advertise the user's skills, presenting on the display a second UI prompting the user to enter his or her qualifications and/or skill sets; and
sending the qualifications and/or skills sets to social networking friends of the user appearing in one or more address books stored in the computing device.

16. The computing device of claim 15, wherein responsive to the user entering the qualifications and/or skill sets and selecting enter, the qualifications and/or skill sets of the user are sent via social networking services to the networking friends.

17. The computing device of claim 15, wherein the instructions include presenting on the display a third UI allowing the user to upload a troubleshooting solution the user developed, the third UI including fields for the user to input a problem description and step by step instructions for resolving the problem.

18. The computing device of claim 17, wherein the instructions for resolving the problem are embodied as a flash file.

19. The computing device of claim 17, wherein the processor sends the instructions for resolving the problem to friends in the user's social networking address book(s) via appropriate social networks such that friend computers of the user of the computing device can receive the instructions for resolving the problem without requesting the instructions for resolving the problem.
